(19) United States
(12) Patent Application Publication
(10) Pub. No.: US 2026/0331013 A1
(43) Pub. Date: Oct. 22, 2026

(54) SYSTEMS AND METHODS FOR AIR QUALITY SENSING USING A SEGMENTED DISPLAY

(71) Applicant: Tyco Fire & Security GmbH, Neuhausen am Rheinfall (CH)

(72) Inventors: RICHARD DAVID FRIEND, Southampton, PA (US); JUSTIN PASQUALE, West Chester, PA (US)

(73) Assignee: Tyco Fire & Security GmbH, Neuhausen am Rheinfall (CH)

(21) Appl. No.: 19/181,047

(22) Filed: Apr. 16, 2025

(51) Int. Cl. G09G 3/04; G06F 3/02

(52) U.S. Cl. CPC G09G 3/04; G06F 3/0202; G09G 2330/023; G09G 2354/00

(57) ABSTRACT

Systems and methods relate to a control device or sensor device for a building/residence/zone/room. The device includes a power interface configured to receive one or more double A or triple A batteries, a segmented display, a push button interface, and a processing circuit configured to illuminate one of the icons at a time and operate in sleep mode. The segmented display includes a mirror configured to receive ambient light and be the source for back light for the display and a set of first icons configured to indicate a different level of air quality. Each of the icons is a segment. Battery life of the device can be advantageously increased due to the sleep mode and the operation of the display.

### BACKGROUND

The present application relates generally to sensors and/or controllers with a display. Heating, ventilating, or air conditioning (HVAC) systems for environments, including but not limited to residential buildings, can include a controller, such as a thermostat, installed within the building to monitor temperature and to provide control signals to HVAC equipment. The thermostats may display information to a user on a user interface/display. The information on the display may be provided from a temperature sensor. Thermostats can include wireless circuitry for communicating information. Wireless thermostats often include energy consuming components such as temperature sensors, user interfaces, communication circuits, controller circuits and displays which require power. The battery life of such thermostats can be short lived due to energy consumption by the energy consuming components.

### SUMMARY

Some embodiments relate to a device for a building. The device includes a power interface configured to receive one or more AA or AAA batteries, a segmented display, a wireless communication circuit, a push button interface, and a processing circuit. The sleep mode is exited in response to a selection received at the push button interface. The segmented display includes a mirror configured to receive ambient light and to be the source for back light for the display and a set of first icons configured to indicate a different level of air quality. Each of the icons is a segment. The processing circuit is configured to activate one of the icons at a time and operate in sleep mode. The sleep mode is exited in response to a selection received at the push button interface. Battery life of the device is advantageously increased due to the sleep mode and the operation of the display.

In some embodiments, the device is a thermostat or sensor, and the display includes a second icon indicating a carbon dioxide capability. In some embodiments, the set of the first icons includes three icons. In some embodiments, the display includes a segmented display element portion configured to display numbers associated with a temperature setpoint. In some embodiments, the display comprises a second icon configured to indicate occupancy. In some embodiments, the display is a monochrome display. In some embodiments, each of the first icons are a combination of text, a first symbol, and a cloud graphic.

Some embodiments relate to a method of displaying information on a thermostatic or sensor device. The method includes sensing a carbon dioxide level and providing one of a set of first icons configured to indicate a different level of carbon dioxide. Each of the icons is a segment on a black and white segmented display including a mirror configured to receive ambient light and configured to be the source for back light for the display.

In some embodiments, the method also includes operating in a sleep mode with the display not displaying one of the first icons, exiting the sleep mode in response to a selection received at the push button interface, and displaying one of the first icons. Battery life of the device is increased due to the sleep mode and the operation of the display. In some embodiments, the device is a thermostat, and the display includes a second icon indicating a carbon dioxide capability. In some embodiments, the set of the first icons includes three icons. In some embodiments, the method also includes displaying a segmented display element portion configured to display numbers associated with a temperature setpoint.

In some embodiments, the method also includes displaying a second icon configured to indicate occupancy. In some embodiments, the display does not include a backlight. In some embodiments, the device has a battery life of five years. In some embodiments, the method also includes displaying a numerical level of the carbon diode level using a segmented portion of the display next to a carbon dioxide icon. In some embodiments, the first icons indicate a first carbon dioxide level below a first threshold, a second carbon dioxide level below a second threshold and above the first level, and a third carbon dioxide level above the second threshold.

Some embodiments relate to a control device for controlling HVAC equipment. The control device includes a processing circuit configured to provide a control signal to HVAC equipment in response to a temperature sensed by a temperature sensor and operate in a sleep mode. The device also includes a segmented display. The segmented display includes a mirror configured to receive ambient light and be the source for back light for the display. The segmented display also includes a set of first icons configured to indicate a different level of air quality. The icons are each a segment. The device also includes a push button interface. The processing circuit is configured to activate the icons one at a time and operate in sleep mode. The sleep mode is exited in response to a selection received at the push button interface. Battery life of the device is increased due to the sleep mode and the operation of the display.

In some embodiments, the first icons include a two dimensional graphical representation. In some embodiments, the first icons each include text indicating carbon dioxide.

One implementation of the present disclosure is a control device for a building. The control device includes a segment display. The segment display includes icons for representing carbon dioxide levels or other air quality levels. In some embodiments, the control device is a thermostat configured for long battery life.

### BRIEF DESCRIPTION OF THE DRAWINGS

Some embodiments of the disclosure are described below with reference to the following figures, wherein like numerals indicate like elements.

FIG. 1 is a schematic perspective view drawing of a building equipped with a heating, ventilation, or air conditioning (HVAC) system, according to some embodiments.

FIG. 2 is a front view planar schematic drawing of a thermostat or sensor associated with the system illustrated in FIG. 1 or other HVAC system, according to some embodiments.

FIG. 3 is a general block diagram of a thermostat or sensor, which can be used in the system of FIG. 1 and other HVAC systems, according to some embodiments.

FIG. 4 is a front planar view schematic drawing of a thermostat, which can be used in the system of FIG. 1 or other HVAC system, according to some embodiments.

FIG. 5 is a front view planar schematic drawing of a face of a display associated with the thermostats or sensors illustrated in FIGS. 2 and 4 showing certain icons, according to some embodiments.

FIG. 6 is a front view planar schematic drawing of a face of a display associated with the thermostats or sensors illustrated in FIGS. 2 and 4 showing all available icons, according to some embodiments.

FIG. 7 is a front perspective view schematic drawing of a thermostat, which can be used in the system illustrated in FIG. 1 or other HVAC system and include the features described with reference to FIGS. 2-6, according to some embodiments.

FIG. 8 is a front planar view schematic drawing of the thermostat illustrated in FIG. 7, according to some embodiments.

FIG. 9 is a rear planar view schematic drawing of the thermostat illustrated in FIG. 7, according to some embodiments.

FIG. 10 is a side planar view schematic drawing of the thermostat illustrated in FIG. 7, according to some embodiments.

FIG. 11 is a side planar view schematic drawing of the thermostat illustrated in FIG. 7, according to some embodiments.

FIG. 12 is a side planar view schematic drawing of the thermostat illustrated in FIG. 7, according to some embodiments.

FIG. 13 is a side planar view schematic drawing of the thermostat illustrated in FIG. 7, according to some embodiments.

FIG. 14 is a rear perspective view schematic drawing of the thermostat illustrated in FIG. 7, according to some embodiments.

### DETAILED DESCRIPTION

### Overview

Referring generally to the FIGURES, a thermostat or sensor is configured to provide sensing and/or control operations while consuming less power than conventional devices. In some embodiments, the thermostat or sensor includes a display configured to provide air quality information (e.g., indications of carbon dioxide levels and numerical readings). In some embodiments, the thermostat or sensor is a wireless sensor with a pushbutton interface and a display that provides air quality information using a segmented display. The thermostat or sensor can be used with any component in a heating, ventilation, or air conditioning (HVAC) system.

The display includes one or more segments that, when provided electrical signals, display characters or icons on the display in some embodiments. The display can include various segments, such as segments that indicate carbon dioxide levels. In some embodiments, segments are used to provide numerical temperature and carbon dioxide levels as well as icons of carbon dioxide levels and setpoints of temperature levels. The display advantageously does not include a backlight and uses a mirror to illuminate the display, thereby saving power. In some embodiments, the thermostat or sensor does not include a touch screen and instead relies upon user actuated buttons, thereby saving power.

In some embodiments, a wireless sensor or thermostat is configured to have a battery life of five years or more and provide carbon dioxide level sensing and display of information related to the sensing of carbon dioxide. The combination and/or orientation in how the characters are located, as well as the number of segments within the segment package, provides an accurate and easy to use display that does not require a large battery draw of power in some embodiments. In some embodiments, the combination of the use of sleep modes and a mirrored, non-backlit segmented display with a push button interface advantageously provides significant visual information to a user while achieving battery lives around five years which is twice as long as conventional sensors or thermostats providing similar information using touch screen units, color displays, and non-segmented displays.

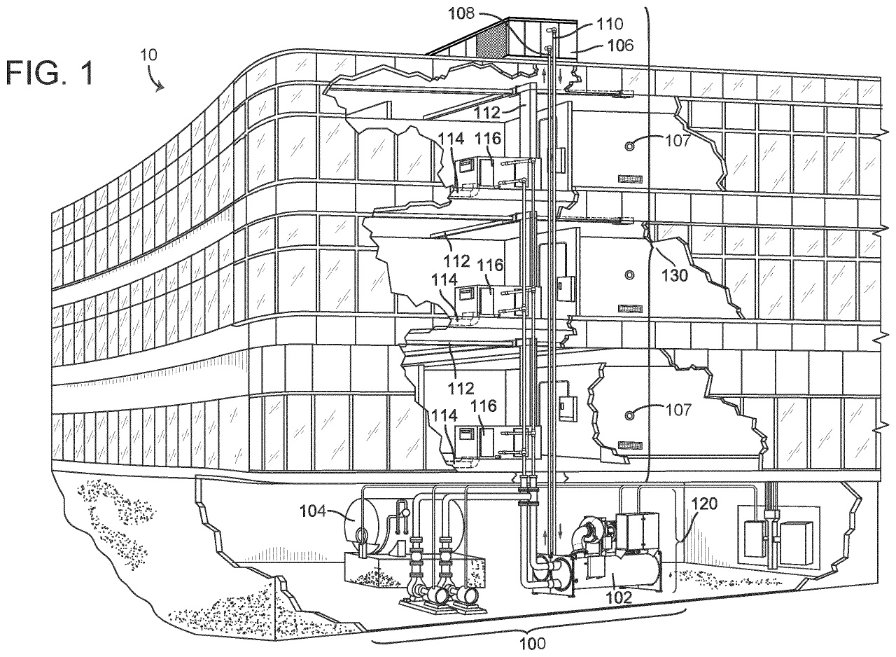

Referring now to FIG. 1, a perspective view of a building 10 is shown. Building 10 is served by a building management system (BMS). A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

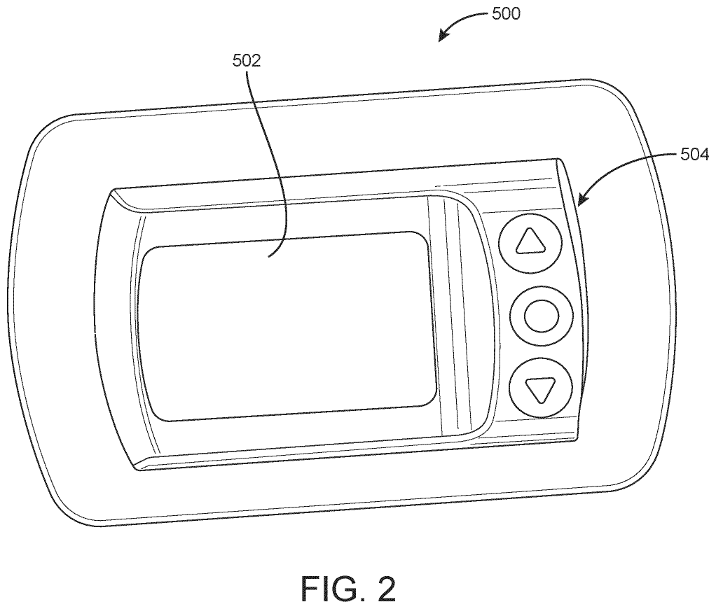

The BMS that serves building 10 includes an HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 can include a waterside system 120 and an airside system 130. Waterside system 120 may provide a heated or chilled fluid to an air handling unit of airside system 130. Airside system 130 may use the heated or chilled fluid to heat or cool an airflow provided to building 10. In some embodiments, waterside system 120 is replaced with a central energy plant such as central plant 200, described with reference to FIG. 2.

Still referring to FIG. 1, HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that can be operated to control an amount of the supply airflow provided to individual zones of building 10. In other embodiments, airside system 130 delivers the supply airflow into one or more zones of building 10 (e.g., via air supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

Sensors or thermostats 107 can be provided throughout the building to provide building, room, and/or zone control and sensing and display of information related to such sensing and control in some embodiments. Sensors or thermostats 107 are wireless thermostats or sensors capable of displaying air quality information (e.g., carbon dioxide levels, Vox levels, particulate levels, pathogen levels, etc.) and have a long battery life as described herein. Although shown in a BMS or HVAC environment in FIG. 1, sensors or thermostats can be employed in a single HVAC system or component environment for a single room, multiple rooms, a residence, or an entire building in some embodiments.

Sensors or thermostats 107 are configured to wirelessly communicate with one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client interfaces or devices can be a computer workstation, a client terminal, a remote or local interface, or any other type of user interface device. For example, client devices can include a desktop computer, a computer server with a user interface, a laptop computer, a tablet, a smartphone, a PDA, or any other type of mobile or non-mobile device. Sensors and thermostats 107 also include a button interface for receiving inputs from a user directly interfacing with the sensors or thermostats 107 in some embodiments.

Sensors and thermostats 107 can also be employed to automatically monitor and control various building functions (e.g., operations related to building electrical subsystems, information communication technology (ICT) subsystems, a security subsystems, HVAC subsystems, lighting subsystems, a lift/escalators subsystems, fire safety subsystems, refrigeration subsystems, advertising or signage subsystems, cooking subsystems, vending subsystems, printer or copy service subsystems, or any other type of building subsystem that uses controllable equipment and/or sensors to monitor or control building 10). Sensors and thermostats 107 can be or include one or more wired or wireless communications interfaces (e.g., jacks, antennas, transmitters, receivers, transceivers, wire terminals, etc.) for conducting data communications with building subsystems or other external systems or devices. In various embodiments, communications via interfaces can be direct (e.g., local wired or wireless communications) or via a communications network (e.g., a WAN, the Internet, a cellular network, etc.). For example, interfaces can include an Ethernet card and port for sending and receiving data via an Ethernet-based communications link or network. In another example, interfaces can include a Wi-Fi transceiver for communicating via a wireless communications network. In another example, interfaces can include cellular or mobile phone communications transceivers. In one embodiment, sensors and thermostats 107 include a power line communications interface and BMS interface is an Ethernet interface. In some embodiments, an interface for sensors and thermostats 107 are each a single wireless interface configured for communications with less battery power drain.

In some embodiments, sensors and thermostats 107 include a processing circuitry including a processor and memory. Processing circuitry can be communicably connected to a BMS interface and/or communications interfaces. The processing circuitry is configured for low power operation and operates in sleep states that are awoken periodically by user interaction using a button interface or by communication via interface. The processor is a low power processor in some embodiments.

The memory (e.g., memory, memory unit, storage device, etc.) can be provided with the processor and include one or more devices (e.g., RAM, ROM, Flash memory, hard disk storage, etc.) for storing data and/or computer code for completing or facilitating the various processes, layers and modules described in the present application. Memory can be or include volatile memory or non-volatile memory. Memory can include database components, object code components, script components, or any other type of information structure for supporting the various activities and information structures described in the present application. According to an example embodiment, the memory is communicably connected to the processor and includes computer code for executing (e.g., by the processor) one or more processes described herein. The memory is a low power, programmable static memory in some embodiments.

Sensors and thermostats 107 can include one or more environmental sensors (e.g., temperature, carbon dioxide, relative humidity, air quality sensor, occupancy sensor, and the like). Sensors and thermostats 107 can receive inputs and schedules relate to the sensors listed above in some embodiments. The inputs can also include inputs such as electrical use (e.g., expressed in kWh), thermal load measurements, pricing information, projected pricing, smoothed pricing, curtailment signals from utilities, and the like.

Referring now to FIG. 2, a drawing of a sensor or thermostat 500 for controlling building equipment is shown, according to an exemplary embodiment. The thermostat 500 includes a display 502 and can be used with the systems illustrated in FIG. 1 or a residential system (e.g., as one or more of sensors or thermostats). The display 502 may be an interactive display that can display information to a user and receive input from the user at a pushbutton or user interface 504. The display 502 can be a black and white, non-color, or monochrome display that includes a mirror for reflecting ambient light. In some embodiments, thermostat 500 does not include an active back light or power consuming back light. In some embodiments, display 502 is a segmented electronic display that uses individual, shaped elements (called segments) which can be turned on or off independently to create visible characters or symbols. The display can include portions forming a seven-segment display used to show numbers. The segmented display can be a monocolor, liquid crystal display (LCD). Thermostat 500 can operate in a sleep mode where display 502 is blank.

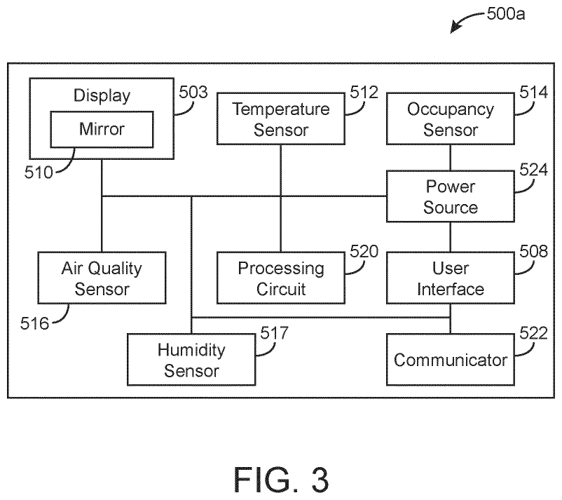

In some embodiments, thermostat 500 has multiple levels of sleep mode. In a first display sleep mode, display 502 consumes minimal power and does not actuate any segments. In a second display sleep mode, display 502 only displays a temperature reading and alarms and all other segments are not actuated. The display sleep modes can be chosen via user interface 504, a remote device, or a server in some embodiments. Thermostat 500 can awaken form either sleep mode and provide full actuation of elements on the display 502 in response a user approaching thermostat 500, sensing occupancy, interaction with user interface 504, an alarm, or a signal from a remote device or server. In some embodiments, sleep modes can include processer-based sleep modes where processors and/or sensors, temperature sensor 512 (FIG. 3), occupancy sensor 514 (FIG. 3), air quality sensor 516 (FIG. 3), communication module 522(FIG. 3), etc.) also enter sleep states where less power is used by such components. In such modes, the components can be woken up periodically to check for new readings, alarms, etc. In some modes, the sampling rate of sensors and transmit rate of sensors can be decreased in a sleep mode. The thermostat 500 can be configured to generate control signals for an indoor unit and/or outdoor unit.

With reference to FIG. 3, thermostat 500a can be used as thermostat 500. Thermostat 500a can be connected to or include an indoor ambient temperature sensor 512, an air quality sensor 516 (e.g., one or more of a carbon dioxide sensor, particulate sensor, pathogen sensor, Vox sensor, etc.), and an occupancy sensor 514. Thermostat 500a includes a processing circuit 520 configured to receive sensor inputs and provide control outputs and display outputs. Thermostats 500a also includes a user interface 508 (e.g., interface 504 in FIG. 2) configured to receive user selections. Processing circuit 520 can be a microcontroller. Thermostat 500 also includes communication module 522 and power source 524.

Processing circuit 520 can include a display controller and a communications controller. Processing circuit 520 includes a processor and memory. Processing circuit 520 can be communicably connected to a BMS interface and/or communications interfaces such that processing circuit 520 and the various components thereof can send and receive data via an interface or module 522. The processor can be implemented as a general purpose processor, an application specific integrated circuit (ASIC), one or more field programmable gate arrays (FPGAs), a group of processing components, or other suitable electronic processing components. Processing circuit 520 is configured for low power operation and operates in sleep states that are awoken periodically by user interaction using a button interface or by communication via communication module 522. The processor is a low power processor in some embodiments.

A memory (e.g., memory, memory unit, storage device, etc.) can be included in circuit 520 and includes one or more devices (e.g., RAM, ROM, Flash memory, hard disk storage, etc.) for storing data and/or computer code for completing or facilitating the various processes, layers and modules described in the present application. Memory can be or include volatile memory or non-volatile memory. Memory can include database components, object code components, script components, or any other type of information structure for supporting the various activities and information structures described in the present application. According to an example embodiment, memory includes computer code for executing (e.g., by processing circuit 520) one or more processes described herein. Memory is a low power, programmable static memory in some embodiments.

Thermostat 500a is powered by a power supply or power source 524 (e.g., one or more batteries (e.g., two AA or AAA batteries)) in some embodiments. In some embodiments, batteries are dry cell batteries providing a voltage of 1.5 volts nominal and having a capacity of 600-1200 milliampere hours or 1800-2850 milliampere hours. In some embodiments, the combination of the use of sleep modes and a mirrored, non-backlit segmented display with a push button interface allows power supply or source 524 to have a battery life around five years when two or three AA batteries are used.

The temperature sensor 512 can be or include an indoor ambient temperature sensor, and/or an outdoor ambient temperature sensor, both of which can be any kind of temperature sensor (e.g., thermistor, thermocouple, etc.). The thermostat 500 may measure the temperature of a room, zone, or residence via the indoor ambient temperature sensor. Further, the thermostat 500a can be configured to receive the temperature from outside a residence or building via communication with the outdoor unit controller. In various embodiments, the thermostat 500 generates control signals for the indoor unit, the outdoor unit based, vents, fans, etc. based on the indoor ambient temperature (e.g., measured via sensor 512), the outdoor temperature, a temperature set point, air quality, air quality set point, humidity, humidity set point or other criteria. Occupancy sensor 514 can be any type of occupancy sensor (e.g., passive infrared (PIR) sensors, ultrasonic sensors, microwave sensors, and dual-technology sensor). Air quality sensor 516 can be any type of air quality sensor (e.g., carbon dioxide (CO2) sensors, non-dispersive infrared (NDIR) sensors, carbon monoxide (CO) sensors, nitrogen dioxide (NO2) sensors, ozone (O3) sensors: volatile organic compounds (VOC) sensors, etc. Sensor or thermostat 500a can also include a humidity sensor 517.

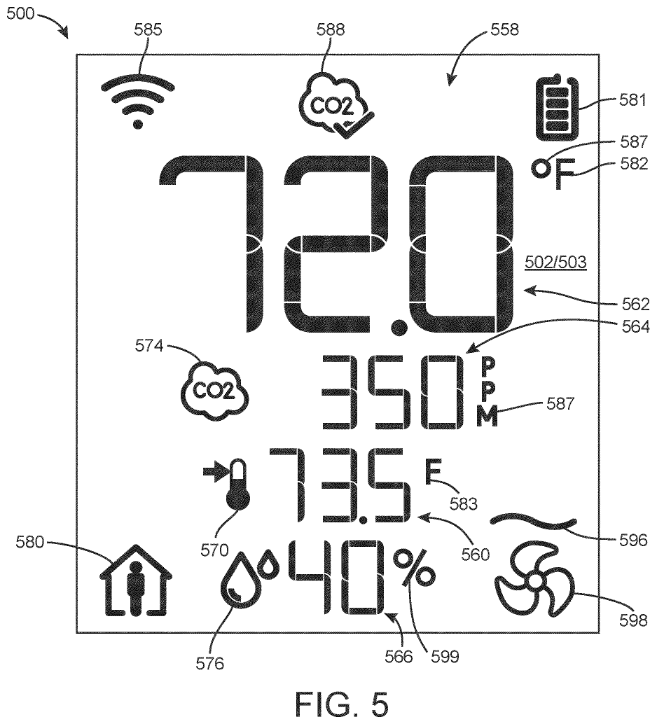

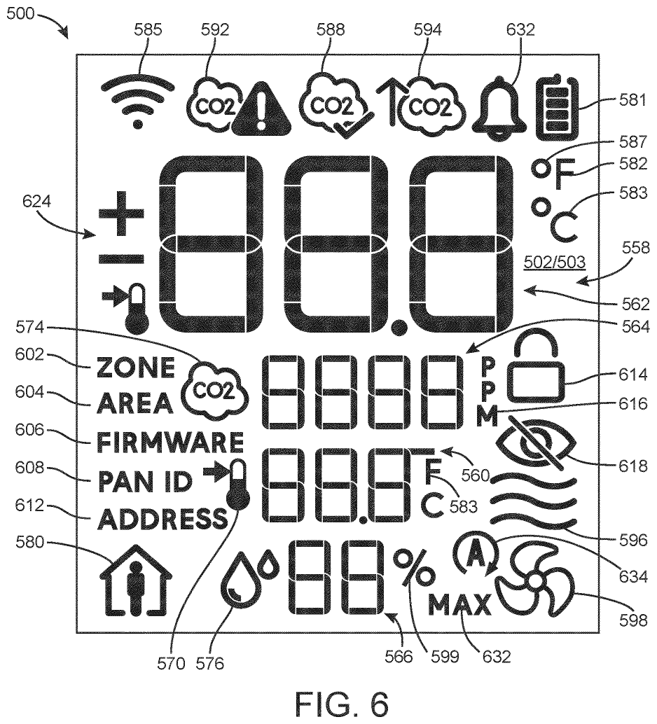

Display 503 is a segmented display and includes a mirror 510. Mirror 510 is a planar mirror disposed beneath LCD elements of display 503 in some embodiments. Mirror 510 is a sole source of back light in some embodiments. In some embodiments, mirror 510 is configured to reflect ambient light as the back light. Mirror 510 is a silvered surface in some embodiments. Details regarding user interfaces 504 and 508 and displays 502 and 503 are described in greater detail below with reference to FIGS. 5-6.

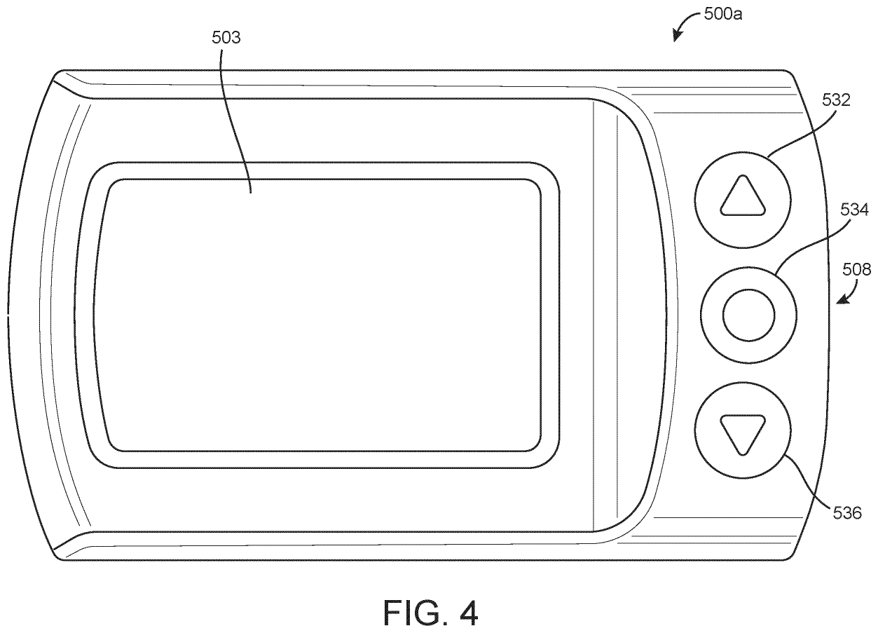

User interface 508 may be configured to receive content from a user. In some embodiments, user interface 508 is a set of pushbuttons or other selectors. In various embodiments, user interface 504 includes various buttons, lights, and/or switches for receiving various inputs. With reference to FIG. 4, user interface 508 similar to user interface 504 (FIG. 2) and includes a set of three push buttons including an up key 532, an enter or select key 534, and a down key 536. In some embodiments, processing circuit 520 exits the sleep mode in response to pushing one of keys 532, 534, or 536. Keys 532, 534, or 536 can be used to enter setpoints, select options in menus, and enter or exit modes.

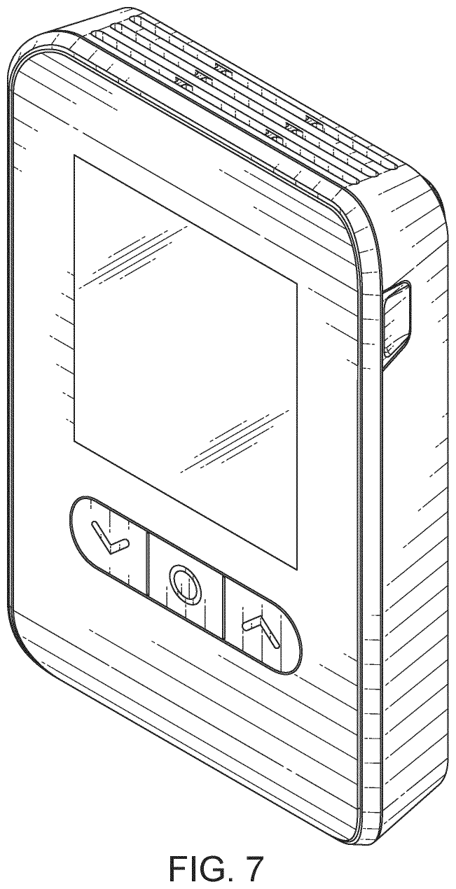

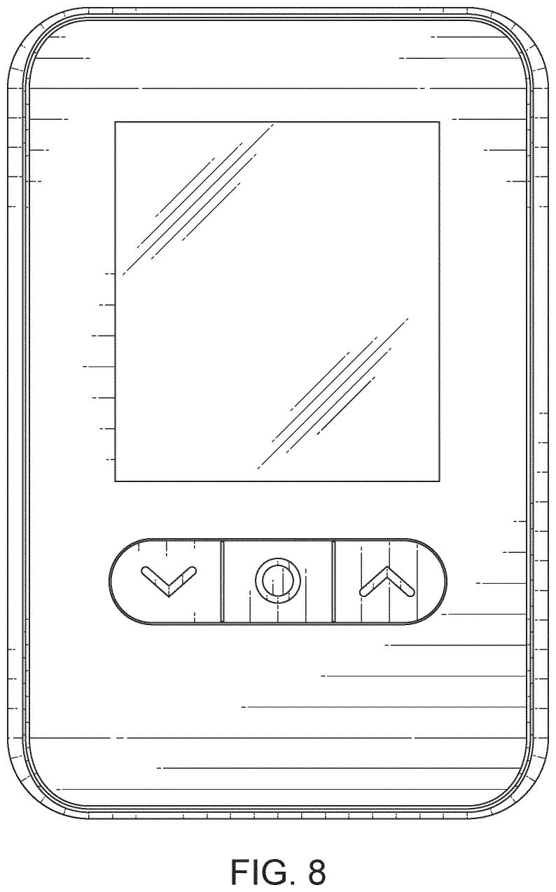

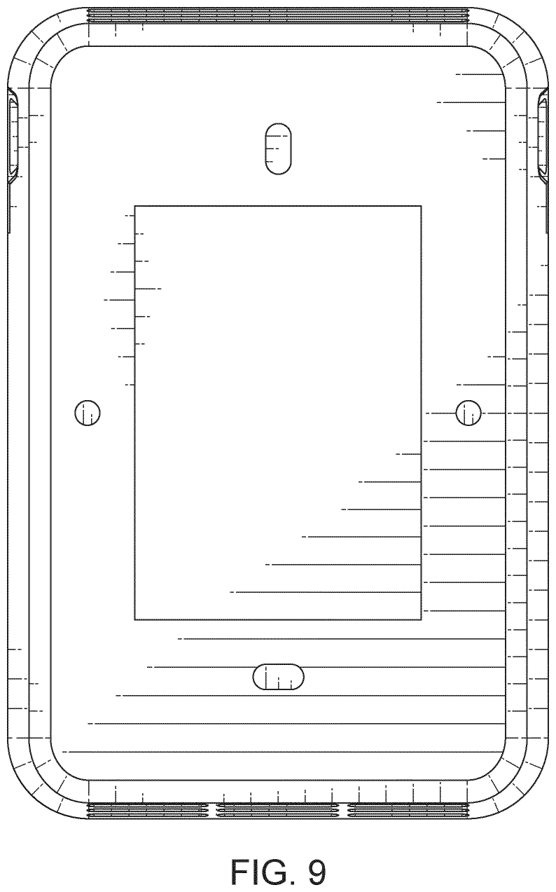

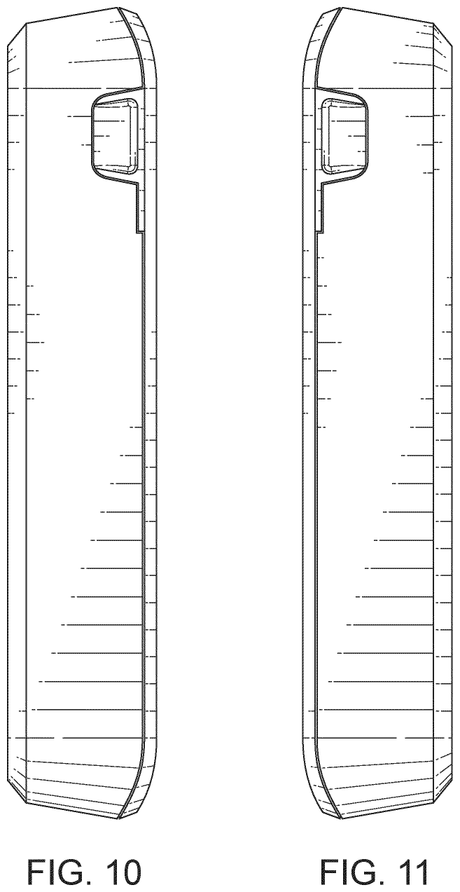

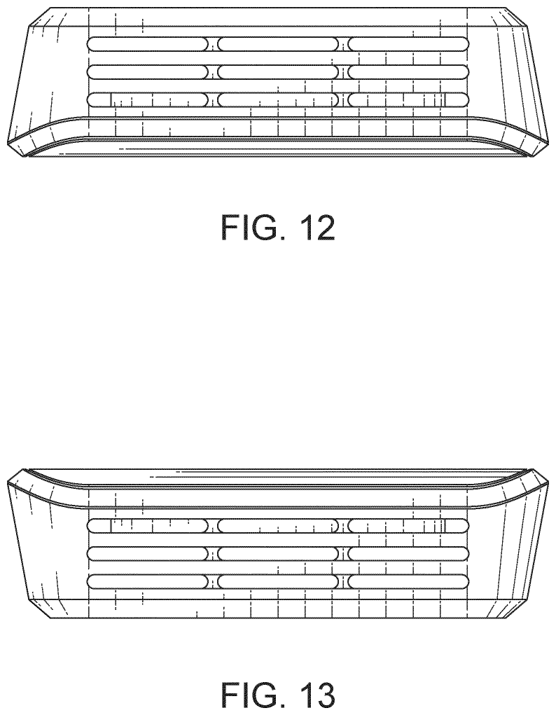

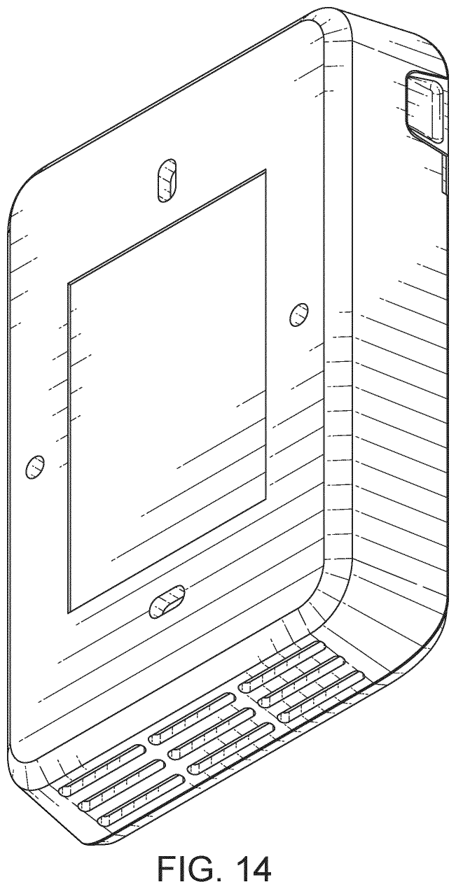

Referring generally to FIGS. 5-6, different embodiments of displays 502 and 503 for sensors or thermostats 500 and 500a are shown, according to some embodiments. FIGS. 5-6 may represent different embodiments of a display for a single thermostat application or setting within thermostats 500 and 500a (FIG. 6 shows all available icons on display 502 while FIG. 5 shows icons for an operational mode of thermostat 500). Displays 502 and 503 can include multiple different configurations to view information regarding an HVAC system and is not limited to the embodiments disclosed herein. FIGS. 7-13 may represent different embodiments of a thermostat 500 or 500a.

Displays 502 and 503 are configured as a segmented, monochrome display and includes segments for displaying icons and segments such as 7-segment characters in some embodiments. The icons can be provided for air quality, occupancy, humidity, fan speed, etc. Keys 532, 534, or 536 may be configured to allow a user to interact with thermostat 500. For example, a user may press center, mode select, or enter button 534 to bring up a menu on display 502. The menu may include temperature settings, temperature modes, device information (e.g., status of furnace, air conditioning unit, boilers, chillers, etc.), setpoint settings, or other settings typically found in thermostat menus. Top or up button or key 532 and bottom or down button or key 534 may be used to select through a series of choices on a menu. For example, keys 532 and 534 may be allow a user to switch from a “settings” page to a “display configuration” page. In some embodiments, keys 532, 534, and 536 are configured to allow a user to select between different temperature settings, humidity settings, etc. (e.g., setpoints, enabling AC, enabling heat, etc.). For example, a user may interact with up button or key 532 to increase temperature or interact with bottom button or key 536 to decrease temperature.

Segments 558 may be configured to represent any type of segmented image, icon, character, or number on displays 502 and 503. Segments 558 may be electrically connected to a device in any form that electronically displays numerals, letters, or images using segment displays, such as displays 502 and 503. In some embodiments, one or more segments 558 are grouped together (e.g., seven, nine, fourteen, etc.) such that the segments are arranged to display various letters or numbers (i.e., a character) (e.g., for a temperature setpoints 560, a temperature reading 562, an air quality reading 564, or a humidity reading 566 next to a percentage icon 599). For example, seven segments may be included within a certain device (e.g., liquid crystal display devices, electrochromic display devices, etc.) such that a 7-segment display device illuminates a character on displays 502 and 503, such as 7-segment character. The 7-segment display device may also include a decimal point package. Reading 564 is provided next to a unit segment 587 indicating part per million units.

A temperature setpoint icon 570 as a single segment can be provided adjacent setpoint 560 and a temperature unit icon 583. A temperature unit icon 582 (e.g., a degree a symbol with C or F indicated) is provided next to segments for the temperature reading 562. A humidity icon 576 as a single segment can be provided adjacent humidity reading 566. An air quality icon 574 as a single segment can be provided adjacent air quality reading 564. Icon 574 can indicate an air quality capability of thermostat 500 or 500a. An occupancy icon 580 as a single segment can be provided to indicate occupancy. A degree icon 587 as a single segment can be provided adjacent temperature reading 562. A unit indicating air quality level can be provided as a single segment. In some embodiments, air quality level for each level (e.g., high, low and normal) are each provided as a single segment. An icon 588 indicates normal air quality. An icon 581 can indicate battery strength and can be composed of multiple segments. Icons 624 are a positive and negative symbols for indicating whether the temperature reading is above or below a setpoint in some embodiments.

Icon 588 can be comprised of text “CO₂” and a check mark indicating normal levels of CO₂. With reference to FIG. 6, an icon 592 can be comprised of text “CO₂” and an exclamation point indicating below normal levels of CO₂. Icon 594 can be comprised of text “CO₂” and an arrow up mark indicating normal levels of CO₂.

The text CO₂ of icons 588, 592, and 594 can be provided in a cloud graphic. Icon 592 can indicate a carbon dioxide level below a first threshold, icon 588 can indicate a second carbon dioxide level below a second threshold and above the first level, and icon 594 can indicate a third carbon dioxide level above the second threshold in some embodiments. Icon 574 can also include text CO₂ provided in a cloud graphic. An icon 632 as a single segment indicates an alarm condition.

An icon 602 can indicate a zone configuration as a single segment. An icon 604 can indicate an area configuration as a single segment. An icon 606 can indicate a firmware mode, and an icon 608 can indicate an address mode (e.g., a personal area address mode). An icon 618 can indicate whether an entry is viewable, and an icon 614 can indicate whether the user interface is locked. An icon 596 can indicate fan speed strength and can include three sperate segments for indicating the level of speed in some embodiments. An icon 598 can indicate fan speed or fan status. An icon 632 can indicate maximum fan speed, and an icon 634 can indicate automatic fan speed control in some embodiments. An icon 585 can indicate network strength and can include three separate segments for indicating the strength in some embodiments.

In some embodiments, segment packages are implemented in various ways to illuminate different images on display 502 and are not limited to segments shown in FIGS. 5-6. For example, 7-segment packages may be implemented to illuminate “72.0” as shown in FIG. 5, which may represent the real-time temperature of a building zone from which thermostat 500 is receiving sensor data. The symbol, numeral, or character that is displayed from various sensor packages may vary, and includes but it not limited to: numerals, alphabet letters, words, symbols, icons, images, or any combination thereof.

In some embodiments, the segments may be illuminated in a manner that allows for animation to appear to occur. In some embodiments, the blink rate (e.g., ⅜ blink per second, ½ blink per second, etc.) for illuminating different segments in display 502 is fast enough to provide the appearance of a constant animation. These animations may include a loading symbol. For example, a character may illuminate the outer segments in a constant circle when thermostat 500 is processing one or more actions (e.g., generating a control signal, analyzing a user input, etc.). The loading animation may also include illuminating the additional segments \ that may branch two characters together, thus providing a more complex animation. Any and all segments in displays 502 and 503 may be illuminated in any order to provide an animation in some embodiments.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A device for a building, the device comprising:
a power interface configured to receive one or more double A or triple A batteries;
a segmented display comprising:
a mirror configured to receive ambient light and be the source for back light for the display;
a set of first icons configured to indicate a different level of air quality, where each of the first icons is a segment;
a wireless communication circuit;
a push button interface; and
a processing circuit configured to
activate one of the first icons at a time and operate in sleep mode, the sleep mode being exited in response to a selection received at the push button interface, whereby battery life of the device is increased due to the sleep mode and the operation of the display.

2. The device of claim 1, wherein the device is a thermostat, and the display comprises a second icon indicating a carbon dioxide capability.

3. The device of claim 1, wherein the set of the first icons comprises three icons.

4. The device of claim 1, wherein the display comprises a segmented display element portion configured to display numbers associated with a temperature setpoint.

5. The device of claim 1, wherein the display comprises a second icon configured to indicate occupancy.

6. The device of claim 1, wherein the display is a monochrome display.

7. The device of claim 1, wherein the first icons each show a cloud with a marking indicating carbon dioxide level.

8. The method of claim 1, wherein the display provides a numerical air quality reading.

9. A method of displaying information on a thermostatic or sensor device, the method comprising:
sensing a carbon dioxide level;
providing one of a set of first icons configured to indicate a different level of carbon dioxide, where each of the first icons is a segment on a black and white segmented display comprising a mirror configured to receive ambient light and be the source for back light for the display;
operating in a sleep mode with the display not displaying one of the first icons; and
exiting in response to a selection received at the push button interface and displaying one of the first icons, whereby battery life of the device is increased due to the sleep mode and the operation of the display.

10. The method of claim 8, wherein the device is a thermostat, and the display comprises a second icon indicating a carbon dioxide capability.

11. The method of claim 8, wherein the set of the first icons comprises three icons.

12. The method of claim 8, further comprising displaying a segmented display element portion configured to display numbers associated with a temperature setpoint.

13. The method of claim 8, further comprising displaying a second icon configured to indicate occupancy.

14. The method of claim 8, wherein the display does not include a backlight.

15. The method of claim 8, wherein the device has a battery life of five years.

16. The method of claim 8, further comprising:
displaying a numerical level of a carbon diode level using a segmented portion of the display and next to a carbon dioxide icon.

17. The method of claim 8, wherein the first icons indicate a first carbon dioxide level below a first threshold, a second carbon dioxide level below a second threshold and above the first threshold, and a third carbon dioxide level above the second threshold.

18. A control device for controlling HVAC equipment, the control device comprising:
a processing circuit configured to provide a control signal to HVAC equipment in response to a temperature sensed by a temperature sensor and operate in a sleep mode; and
a segmented display comprising:
a mirror configured to receive ambient light and be the source for back light for the display;
a set of first icons configured to indicate a different level of air quality, where each of the first icons is a segment; and
a push button interface; and
wherein the processing circuit is configured to illuminate one of the first icons at a time and operate in sleep mode, the sleep mode being exited in response to a selection received at the push button interface, whereby battery life of the control device is increased due to the sleep mode and the operation of the display.

19. The control device of claim 18, wherein the first icons comprise a two dimensional graphical representation.

20. The control device of claim 18, wherein the first icons each comprise text indicating carbon dioxide.
